(19) United States
(12) Patent Application Publication
(10) Pub. No.: US 2007/0011333 A1
(43) Pub. Date: Jan. 11, 2007

(54) Automated serial protocol initiator port transport layer retry mechanism

(76) Inventors: Victor Lau, Marlboro, MA (US); Pak-lung Seto, Shrewsbury, MA (US); Suresh Chemudupati, Marlborough, MA (US); Naichih Chang, Shrewsbury, MA (US); Kiran Vemula, Worcester, MA (US); William Halleck, Lancaster, MA (US); Ankit Parikh, Marlborough, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/172,318

(22) Filed: Jun. 30, 2005

(51) Int. Cl. G06F 15/16

(52) U.S. Cl. 709/227

(57) ABSTRACT

Disclosed is an initiator port that implements a transport layer retry (TLR) mechanism. The initiator port includes a circuit having a transmit transport layer and receive transport layer in which both the transmit and receive transport layers are coupled to a link. A transmit protocol processor of the transmit transport layer controls a TLR mechanism in a serialized protocol. A receive protocol processor of the receive transport layer is coupled to the transmit transport layer and likewise controls the TLR mechanism in the serialized protocol.

### BACKGROUND

1. Field

Embodiments of the invention relate to the field of retry mechanisms in serialized protocols. More particularly, embodiments of the invention relate to an automated Serial (Small Computer System Interface (SCSI)) Protocol (SSP) initiator port transport layer retry mechanism.

2. Description of Related Art

Serial Attached SCSI (SAS) is a protocol evolution of the parallel SCSI protocol. SAS provides a point-to-point serial peripheral interface in which device controllers may be directly linked to one another. SAS integrates two established technologies—SCSI and Serial Advanced Technology Attachment (SATA) technologies, combining the utility and reliability of the SCSI protocol with the performance advantages of SATA's serial architecture.

SAS is a performance improvement over traditional SCSI because SAS enables multiple devices of different sizes and types to be connected simultaneously in a full-duplex mode. In addition, SAS devices can be hot-plugged.

Computer devices, storage devices, and various electronic devices are being designed to comply with faster protocols that operate in a serial fashion, such as SAS protocol, to deliver the speed and performance required by today's applications.

In the SAS specification [e.g. Serial Attached SCSI-1.1 (SAS-1.1), American National Standard for Information Technology (ANSI), T10 committee, Revision 09d, status: T10 Approval, Project: 1601-D, May 30, 2005] [hereinafter the SAS standard] defines an SSP initiator port transport layer retry (TLR) requirements for SSP initiator ports.

According to the SAS standard, the SSP initiator port should, upon receipt of a new transfer ready (XFER_RDY) frame with a RETRANSMIT bit set to one, while processing a previous XFER_RDY frame, stop processing the previous XFER_RDY frame and start servicing the new XFER_RDY frame. The initiator port should not send any write data frames for the previous XFER_RDY frame after sending a write data frame for the new XFER_RDY frame.

The SSP initiator port should process link layer errors that occur while transmitting write data frames transmitted in response to an XFER_RDY frame that has it's RETRY DATA FRAMES bit set to one as described as follows.

If a SSP initiator port transmits a write data frame and does not receive an acknowledgement (ACK/NAK timeout) or receives a negative acknowledgement (NAK), the SSP initiator retransmits all the write data frames for the previous XFER_RDY frame. For the ACK/NAK timeout case, the SSP initiator port should close the connection and open a new connection to retransmit the write data frames. In this case, the CHANGING DATA POINTER bit is set to one in the first retransmitted write data frame and to zero in subsequent write data frames. The maximum number of times the SSP initiator port retransmits each write data sequence is typically vender-specific.

On the other hand, if the SSP initiator port receives a new XFER_RDY frame or a RESPONSE frame for a command while retransmitting or preparing to retransmit the write data frame, the SSP initiator port processes the new XFER_RDY frame or RESPONSE frame and stops sending the retransmitted write data frames. In this case, the SSP initiator port does not send a write data frame for the previous XFER_RDY frame after sending a write data frame in response to the new XFER_RDY frame.

These fairly well defined rules set forth in the SAS specification for the SSP initiator port to handle transport layer retries are presently handled in firmware. Firmware implementation introduces a great deal of firmware overhead due to the large amount of required handshaking between firmware and hardware, and a great deal of processor compute cycle time.

### BRIEF DESCRIPTION OF THE DRAWINGS

FIG. 1 is a block diagram illustrating an example of a system in which an SSP initiator port can be utilized.

FIG. 2 is a block diagram illustrating a scatter gather list for an input/output (I/O) command.

FIG. 3 is a block diagram illustrating an I/O context for an ITLQ nexus.

FIG. 4 is a block diagram illustrating an example of an SSP initiator port.

FIG. 5 is a block diagram illustrating an example of an SSP initiator port.

FIG. 6 is a diagram that illustrates how the SSP initiator port handles received retransmit XFER_RDY frames as part of the transport layer retry (TLR) mechanism.

FIG. 7 is a diagram that illustrates how the SSP initiator port handles write data frames as part of the TLR mechanism.

FIG. 8 is a diagram that illustrates how the SSP initiator port implements a TLR mechanism when the SSP initiator port receives a response frame for a command while retransmitting or preparing to retransmit write data frames due to a ACK/NAK timeout or a received NAK.

FIG. 9 is a block diagram illustrating how the SSP initiator port handles read data frame retries as part of the TLR mechanism for I/O read commands.

### DESCRIPTION

In the following description, the various embodiments of the invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the embodiments of the invention, it will be apparent to one skilled in the art that these specific details are not required in order to practice the embodiments of the invention. In other instances details such as, well-known methods, types of data, protocols, procedures, components, electrical structures and circuits, are not described in detail, or are shown in block diagram form, in order not to obscure the invention.

Embodiments of the invention relate to an automated Serial (Small Computer System Interface (SCSI)) Protocol (SSP) initiator port transport layer retry mechanism. Particularly, embodiments relate to a hardware automated SSP initiator port that employs a transport layer retry (TLR) mechanism in both a wide and narrow port configuration, as opposed to utilizing firmware, to thereby improve frame processing latency, reduce protocol overhead, and to improve overall system input/output (I/O) performance. For example, the SSP initiator port may be implemented as a circuit, such as, an integrated circuit.

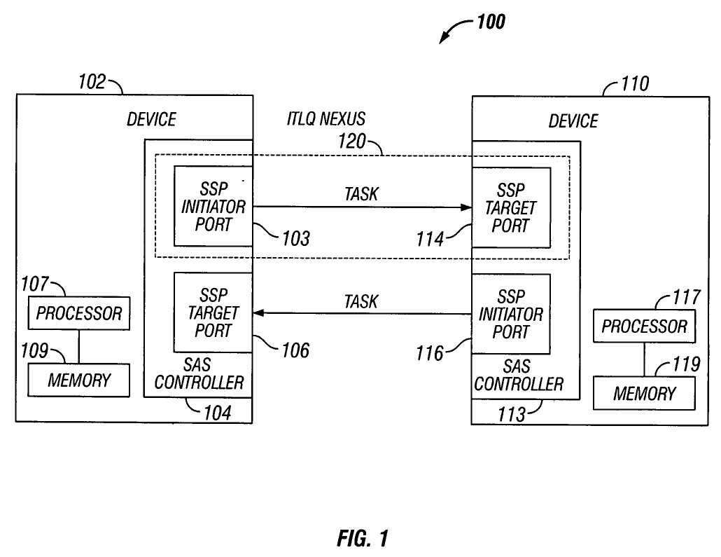

Turning to FIG. 1, FIG. 1 is a block diagram illustrating a system including first device 102 coupled to another device 110, in which each device has an SAS controller 104 and 113, respectively, that includes an SSP initiator port. Device 102 is communicatively coupled to device 110 over a link in accordance with the SAS protocol standard. Each device includes a SAS controller 104 and 113 that is utilized to provide communication between the two devices 102 and 110 in the, respectively, over a respective link.

Device 102 may include a processor 107 to control operations in the device 102 and SAS controller 104 to control serial communication with device 110 in accordance with the SAS standard. Further, device 102 may include memory 109 coupled to processor 107 as well as a plurality of different input/output (I/O) devices (not shown).

Similarly, device 110 may likewise include processor 117 to control operations in device 110 and SAS controller 113 to control serial communication with the other device 102 in accordance with the SAS protocol. Further, device 110 may include memory 119 coupled to processor 117 as well as a plurality of different input/output (I/O) devices (not shown).

Each device may include a SAS controller 104 and 113, respectively. Further, SAS controller 104 may include an SSP initiator port 103 and an SSP target port 106 whereas SAS controller 113 may include an SSP target port 114 and an SSP initiator port 116. In accordance with this example, device 102 through SSP initiator port 103 may communicate a task over a link to SSP target port 114 of SAS controller 113 of device 110.

It should be appreciated that device 102 and device 110 may be any type of device such as a personal computer, laptop computer, network computer, server, router, expander, set-top box, mainframe, storage device, hard disk drive, flash memory, floppy drive, compact disk read-only memory (CD-ROM), digital video disk (DVD), flash memory, hand-held personal device, cell phone, etc., or any sort of device having a processor and/or memory.

Embodiments of the invention relate to a device 102 having an SAS controller 104 that includes an SSP initiator port 103 that communicates a task across a link to another device 110 and the structures and functions by which SSP initiator port 103 implements a transport layer retry (TLR) mechanism, as will be described in detail hereinafter. To aid in this description, a task nexus 120 may be defined as a nexus between SSP initiator port 103, SSP target port 114, a logical unit (comprising the devices, links, and nodes through which a task is transmitted), and the task itself (termed an ITLQ nexus).

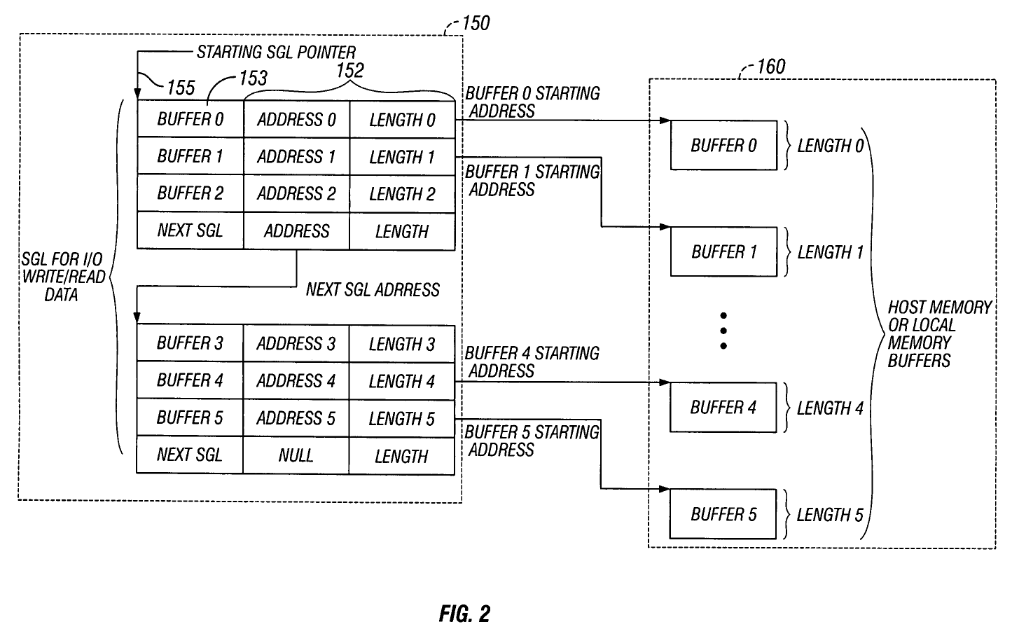

Looking briefly at FIG. 2, FIG. 2 illustrates a scatter gather list (SGL) buffering mechanism 150 that utilizes address length (A/L) pairs 152 to point to and indicate the size of host or local memory buffers 160 that store the receive or transmit frames. Also, SGL buffering mechanism 150 further includes a buffer number field 153 and a SGL pointer 155. The host memory may be memory associated with the device itself such as memory 109 or may be memory of the SAS controller 104 itself. The use of scatter gather list (SGL) memory access is well known and will not be described in detail, and is but one method of memory access that may be utilized with embodiments of the invention.

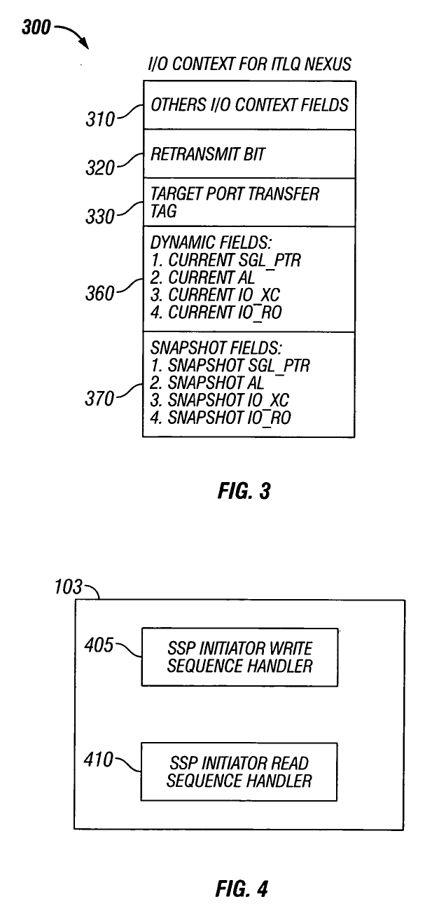

In one embodiment, a plurality of I/O contexts are defined for each task or ITLQ nexus, previously discussed. With reference to FIG. 3, FIG. 3 is a table illustrating I/O contexts for an ITLQ nexus. The I/O context is based on initial I/O read/write information that is passed to the transport layer. The I/O context has dynamic fields that are maintained by the transport layer. A direct memory access (DMA) processor of the SSP initiator port may keep track of the current I/O process and the plurality of I/O context may be stored within the SSP initiator port, as will be described. Particularly, table 300 of FIG. 3 shows these I/O context fields.

For example, the I/O context for an ITLQ nexus may include a retransmit bit 320 and a target port transfer TAG 330.

The I/O context for an ITLQ nexus may further include dynamic fields 360, such as the current scatter gather list pointer (SGL_PTR) which may be a pointer to a local or host memory buffer; the current address length pair (A/L); the current I/O read/write data transfer count (I/O_XC); and the current I/O read/write data relative offset (I/O_RO).

Further, as well as the dynamic fields 360, the I/O context for the ITLQ nexus may further include snapshot fields 370, such as: snapshot SGL_PTR; snapshot A/L; snapshot I/O_XC; and snapshot I/O_RO. The snapshot fields are analogous to the dynamic fields except that they are previously saved fields for use in the SSP initiator port transport layer retry mechanism, as will be described.

As will be described, the transmit transport layer of the SSP initiator port updates the dynamic fields 360 when it transmits a write data frame from the transmit buffer to the link and receives an acknowledgement (ACK). Further, the receive transport layer updates the dynamic fields 360 when the DMA processor transmits a read data frame from the receive buffer to the host or local memory.

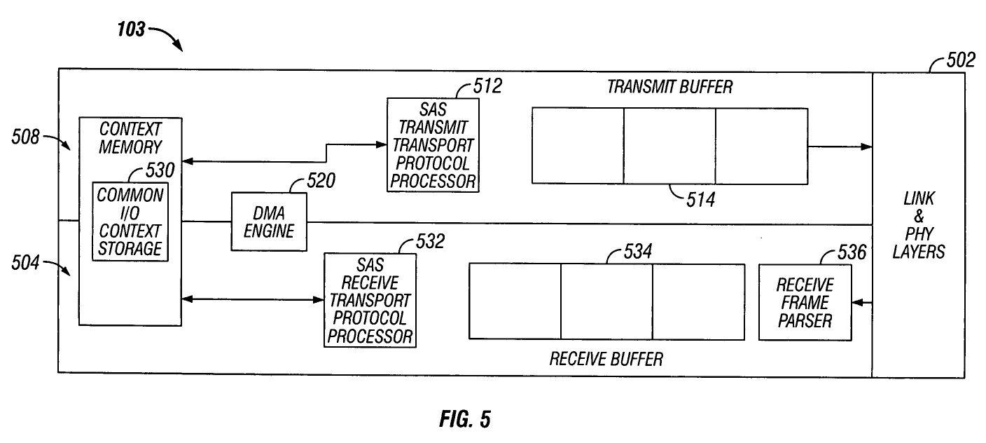

With reference now to FIG. 4, FIG. 4 is a block diagram illustrating an example of an SSP initiator port 103. In one embodiment, an SSP initiator port includes an SSP initiator write sequence handler 405 and an SSP initiator read sequence handler 410. The SSP initiator write sequence handler 405 handles transport layer retry situations for I/O write commands. The SSP initiator read sequence handler 410 handles transport layer retry for I/O read commands. In one embodiment, both the SSP initiator write sequence handler 405 and the SSP initiator read sequence handler 410 may be implemented in hardware as will be described with reference to FIGS. 5-9. More particularly, the SSP initiator write sequence handler 405 may be implemented by a transmit transport layer of the SSP initiator port 103 and the SSP initiator read sequence handler 410 may be implemented by a receive transport layer of the SSP initiator port 103, as will be described in detail hereinafter.

It should be noted that it is assumed that an SSP initiator port 103 assigns a unique TAG for each ITLQ nexus. The TAG field is used by the SSP initiator port 103 to associate an I/O context to a particular ITLQ nexus. If the TAG is not unique across different remote nodes the SSP initiator port 103 concatenates the remote node index with the TAG to form a unique I/O context ID to associate I/O context for a particular ITLQ nexus. Note that, each remote node is assigned a unique remote node index by the device.

With reference now to FIG. 5, FIG. 5 is a block diagram illustrating a SSP initiator port 103, according to one embodiment of the invention. The SSP initiator port 103 includes a receive transport layer 504 and a transmit transport layer 508.

In one embodiment, the initiator port may be hardware based. The initiator port 103 may be a circuit. For example the circuit may be an integrated circuit, a processor, a microprocessor, a signal processor, an application specific integrated circuit (ASIC), or any type of suitable logic or circuit to implement the functionality described herein.

Particularly, the initiator port 103 includes a transmit transport layer 508 and receive transport layer 504 both of which are coupled to a link 502. A transmit protocol processor 512 of the transmit transport layer 508 controls a TLR mechanism in a serialized protocol. A receive protocol processor 532 of the receive transport layer 504 is coupled to the transmit transport layer and likewise controls the TLR mechanism in the serialized protocol.

Particularly, both receive and transmit transport layers 504 and 508 are coupled to link and physical layers 502. Further, both the receive transport layer (RxTL) 504 and transmit transport layer (TxTL) 508 both utilize a direct memory access (DMA) processor 520 and Context Memory.

Looking more particularly at receive transport layer 504, receive transport layer 504 includes a receive frame parser 536 for parsing frames which received from link and physical layer 502, a receive buffer 534 for storing receive frame data, an SAS receive protocol processor 532, and common I/O context storage 530 to store I/O contexts for the ITLQ nexuses as previously discussed with FIG. 3. Receive transport layer 504 implements the SSP initiator read sequence handler 410 functionality, previously discussed.

Looking at the transmit transport layer 508, the transmit transport layer 508 includes common I/O context storage 530 to store the I/O contexts for the ITLQ nexuses (as discussed with reference to FIG. 3), a SAS transmit protocol processor 512, and transmit buffer 514 for storing transmit data (e.g. retry write data) for use in the transport layer retry to be outputted onto link and physical layers 502 (e.g. as retry write data frames). Transmit transport layer 508 implements the SSP initiator write sequence handler 405 functionality, previously discussed.

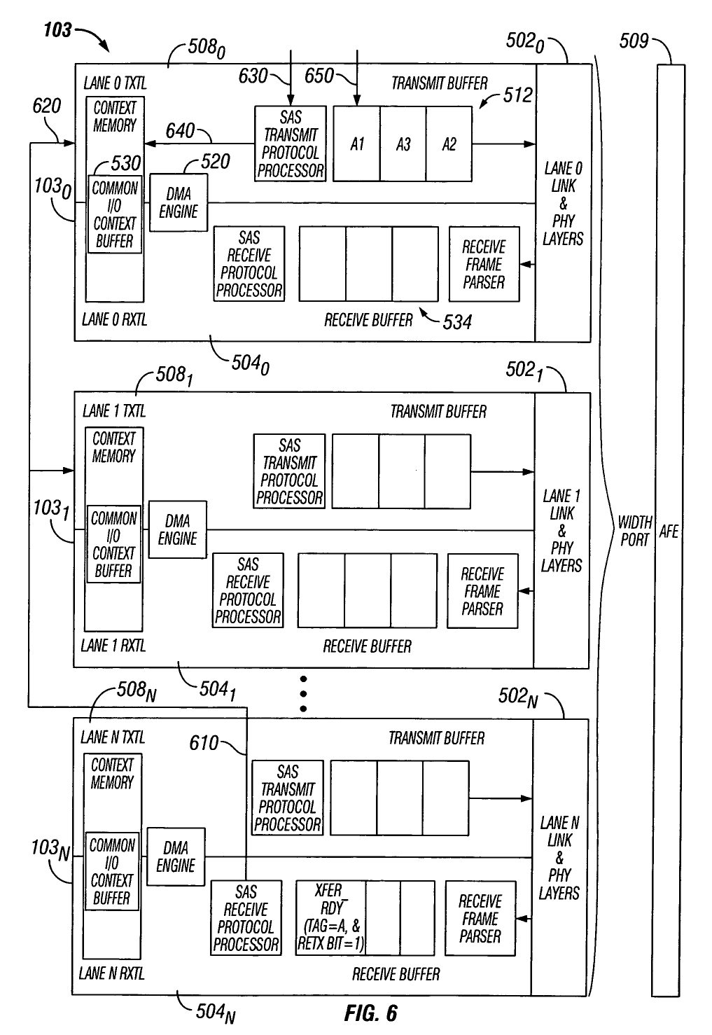

The SAS transmit protocol processor 512 and the SAS receive protocol processor 532 are utilized in implementing SAS standard protocols as well as in implementing aspects of the transport layer retry (TLR) mechanism as will be described. The SAS transmit and receive processors may be any type of suitable processor or logic to accomplish these TLR functions. Additionally, each of the previously discussed components of the SSP initiator port 103 and their respective functionality in implementing aspects of the transport layer retry mechanism will now be discussed in detail with reference to FIGS. 6-9.

With reference now to FIGS. 6-9, FIGS. 6-9 illustrate the operation of the previously-described SSP initiator port 103 as it operates within an SAS controller of a device in implementing a transport layer retry (TLR) mechanism.

Looking particularly at FIG. 6, FIG. 6 is a diagram illustrating an SSP initiator port 103 of an SAS controller and performed functionality to handle a XFER_RDY retry. It should be appreciated that the SSP initiator port 103 may be a narrow SSP initiator port in which there is only one phy associated with the SSP initiator port 103₀ or the SSP initiator port 103 may be a wide port in which there are multiple phys associated with the SSP initiator port, such as shown in FIG. 6, with SSP initiator ports 103_{0-N}.

As illustrated at point 610 of FIG. 6, the SSP initiator port 103_{N} receives a new XFER_RDY frame with a retry indicator (e.g. a RETRANSMIT bit set to one) while processing the previous XFER_RDY frame for an ITLQ nexus (with the same TAGs) and at this point the SSP initiator port 103 stops processing the previous XFER_RDY frame and starts receiving the new XFER_RDY frame.

As shown in FIG. 6, when any of the individual ports 103_{0-N} of this wide SSP initiator port 103 receives a XFER_RDY frame with the RETRANSMIT bit set to one, the receive transport layer 504 broadcasts a message including the received XFER_RDY frame's TAG, REQUESTED OFFSET, WRITE DATA LENGTH and the TARGET PORT TRANSFER TAG FIELDS with a received XFER_RDY frame parameter to all the transmit transport layers 508_{0-(N-1)} (indicated at 610). Also, it should be noted that associated with the various lanes (0-N) link and physical layers 502₀-502_{N} illustrated in FIG. 6, an analog front end 509 is utilized as part of the physical layer to provide a serializer function, analog-to-digital functionality, as well as other physical functionality.

If one of the transmit transport layers 508 is processing the previous XFER_RDY frame for that ITLQ nexus (e.g. transport layer 508₀), the transmit transport layer 508₀ of the SSP initiator port 103 finds that the broadcasted TAG matches its current executing I/O write command TAG. This is the case here as is indicated at 620. Further, the SSP initiator port checks that the new XFER_RDY frame is valid based on the SAS standard before it starts the SSP TLR process. Otherwise, if none of the transmit transport layers 508 is processing the previous XFER_RDY frame, the receive transport layer can start processing the retransmit XFER_RDY frame by setting the retransmit bit in the I/O context for that ITLQ nexus.

First, based upon the SAS standard, the new XFER_RDY frame header includes a different value in its TARGET PORT TRANFSER TAG FIELD. Thus, the transmit transport layer 508₀ of the SSP initiator port 103 updates the I/O context TARGET PORT TRANSFER TAG FIELD for that particular ITLQ nexus. Thus, all the subsequent write data frames use the new TARGET PORT TRANSFER TAG value in their frame header.

It should be noted that if the transmit transport layer 508₀ has a write data frame already on the fly in the link layer it must finish it first. Then, based on the SAS standard, there are two possible ways that the SSP initiator port 103 may stop processing the previous XFER_RDY frame before servicing the new XFER_RDY frame. For example, the transmit transport layer 508₀ of the SSP initiator port 103 may: a) finish transmitting all the write data frames in the transmit buffer 514 and complete all the DMA descriptors already passed to the DMA processor 520; or b) flush all the remaining write data frames in the transmit buffer 514 and terminate all the DMA descriptors already passed to the DMA processor 520. This operation is indicated at point 630 in FIG. 6.

Lastly, in order for the transmit transport layer 508₀ to process the new XFER_RDY frame, the transport layer 508₀ and the receive transport layer 504₀ cooperate to maintain the dynamic and snapshot fields in the I/O context for that ITLQ nexus. Particularly, when any of the receive transport layers 504 in a wide SSP initiator port 103 receives a valid XFER_RDY frame with the RETRANSMIT bit set to zero for any outstanding I/O write commands, it takes a snapshot of the dynamic fields and copies them to the snapshot fields of the I/O context for that ITLQ nexus, as previously discussed with reference to FIG. 3.

Thus, if later the SSP initiator port 103 receives a new XFER_RDY frame with the RETRANSMIT bit set to one for that particular ITLQ nexus, transmit transport layer 508₀ can roll back the dynamic fields in the I/O context to the beginning of the previous XFER_RDY frame by copying the snapshot fields back to the dynamic fields. This enables the transmit transport layer to service the new XFER_RDY frame from the beginning of the new XFER_RDY frame, as is required by the SAS standard. Particularly, as seen at point 650 of FIG. 6, at transmit buffer 514, once the transmit transport layer 508 stops processing the previous XFER_RDY frame, it starts servicing the new XFER_RDY frame by transmitting the retry write data frame from the beginning of the new XFER_RDY . As seen in transmit buffer 514, all the retransmit write data frames have new TARGET PORT TRANSER TAG values in their SSP frame header.

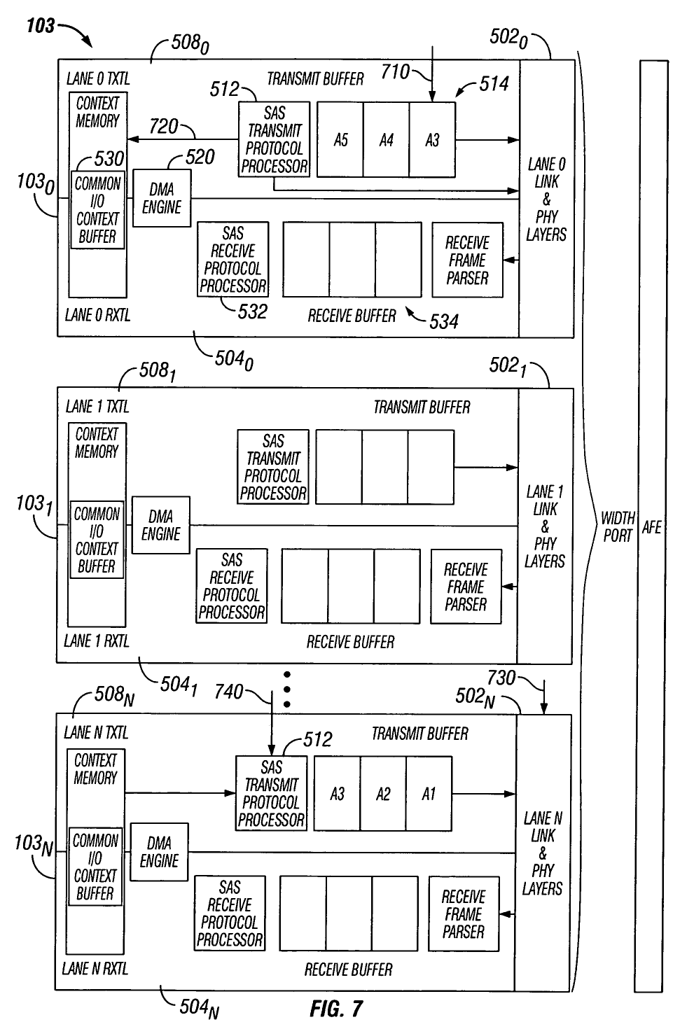

Turning now to FIG. 7, FIG. 7 is a diagram that illustrates how the SSP initiator port 103 handles write data frames as part of the transport layer retry (TLR) mechanism. When the SSP initiator port 103 transmits a write data frame (as shown at point 710) and it does not receive a ACK/NAK (or ACK/NAK timeout) or receives a NAK for that write data frame, it retransmits all the write data frames for the last received XFER_RDY frame. Further, for the ACK/NAK timeout case, the SSP initiator port 103 retransmits all the write data frames in a new connection.

As particularly shown in FIG. 7, at point 710, when the transmit transport layer 508₀ transmits a write data frame from transmit buffer 514 and detects an ACK/NAK timeout or receives a NAK, the transmit transport layer 508 rolls back the dynamic fields in the I/O context to the beginning of the last received XFER_RDY frame by copying the snapshot fields back to the dynamic fields (e.g. see FIG. 3). This enables the transmit transport layer 508 to retransmit all the write data frames for the last received XFER_RDY frame (e.g. A5, A4, A3). This is enabled by the SAS transmit protocol processor 512.

For the ACK/NAK or NAK case, the transmit transport layer requests the link layer to close the connection. In order to handle closing the connection due to the ACK/NAK timeout before the transmit transport layer 508 begins the retry sequence, the transmit transport layer (as shown at point 740 of FIG. 7, for example) sets the RETRANSMIT bit field to one in the I/O context to one such that the I/O write data sequence is in a retry state. Thus, when a new connection is established, the transmit transport layer 508_{N} under the control of the SAS transmit protocol processor 512 checks the retransmit in the common I/O context buffer 530 and finds that its equal to one and starts servicing the I/O write data retry sequence by setting the CHANGE DATA POINTER bit to one for the first retransmitted write data frame.

The maximum number of times a transmit transport layer attempts to retry a write data frame may be programmable by a specific configuration space or mode page, or chip initialization parameter.

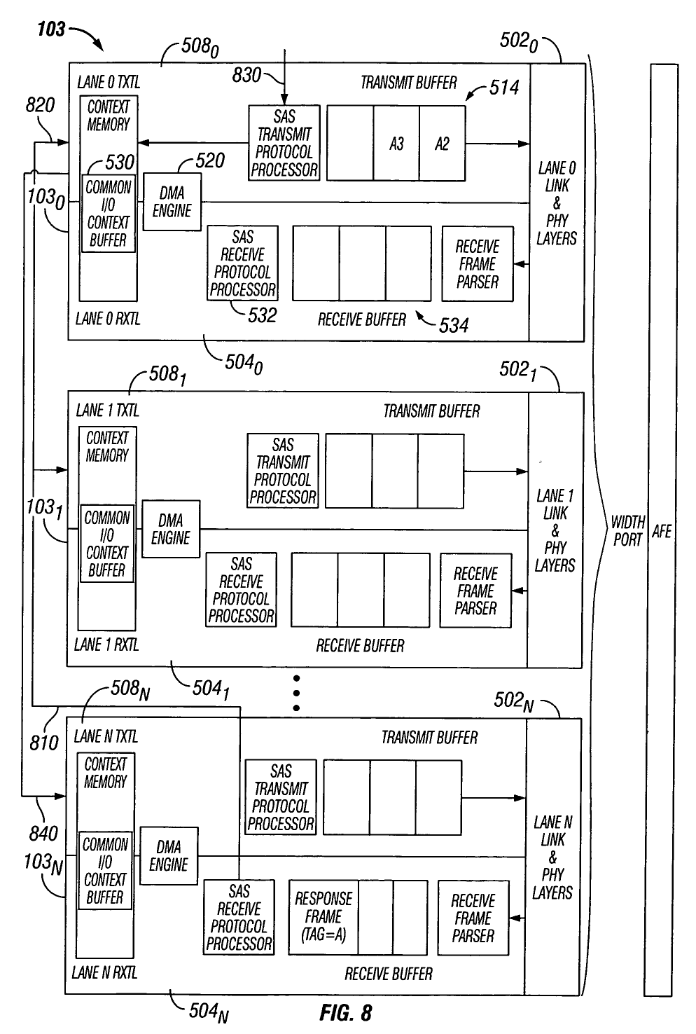

Turning now to FIG. 8, FIG. 8 is a diagram that illustrates how the SSP initiator port 103 implements a transport layer retry (TLR) mechanism when the SSP initiator port receives a response frame for the corresponding ITLQ nexus while retransmitting or preparing to retransmit write data frames due to a ACK/NAK timeout or a received NAK. Particularly, FIG. 8 illustrates how the SSP initiator port processes the response frame and stops sending the retransmit write data frames.

As shown in FIG. 8, when the SSP initiator port 103 at a lane of a wide SSP initiator port (e.g. at point 810) receives a response frame at the receive transport layer (e.g. 504_{N}), that receive transport layer 504_{N} broadcasts the RESPONSE FRAME TAG to all the transmit transport layer 508_{0-(N-1)} in the same SSP initiator port 103. If any of the transmit transport layers are retransmitting or preparing to retransmit write data frames for the previous XFER_RDY for that ITLQ nexus, that transmit transport layer (e.g. 508₀) of that SSP initiator port (e.g. at point 820) will find the broadcasted TAG matching its current executing I/O write TAG. If a transmit transport layer already has write data already on the fly to the link layer 502, it finishes transmitting all the write data in the transmit buffer frames 514. Then, based on the SAS standard, there are two possible ways for the transmit transport layer 508₀ to stop processing the previous XFER_RDY frame before servicing the RESPONSE frame.

For example, the transmit transport layer 508₀ may: a) finish transmitting all the write data frames in the transmit buffer 514 and complete all the DMA descriptors already passed on to the DMA processor 520; or b) flush all the remaining write data frames in the transmit buffer 514 and terminate all the DMA descriptors already passed through the DMA processor 520. After the transmit transport layer 508₀ stops retransmit the retry write data frames, at point 840, the receive transport layer 504_{N} can process the RESPONSE frame.

On the other hand, if none of the transmit transport layer in the same SSP initiator port is retransmitting or preparing to retransmit write data frames for that ITLQ nexus, the receive transport layer can start processing the RESPONSE frame.

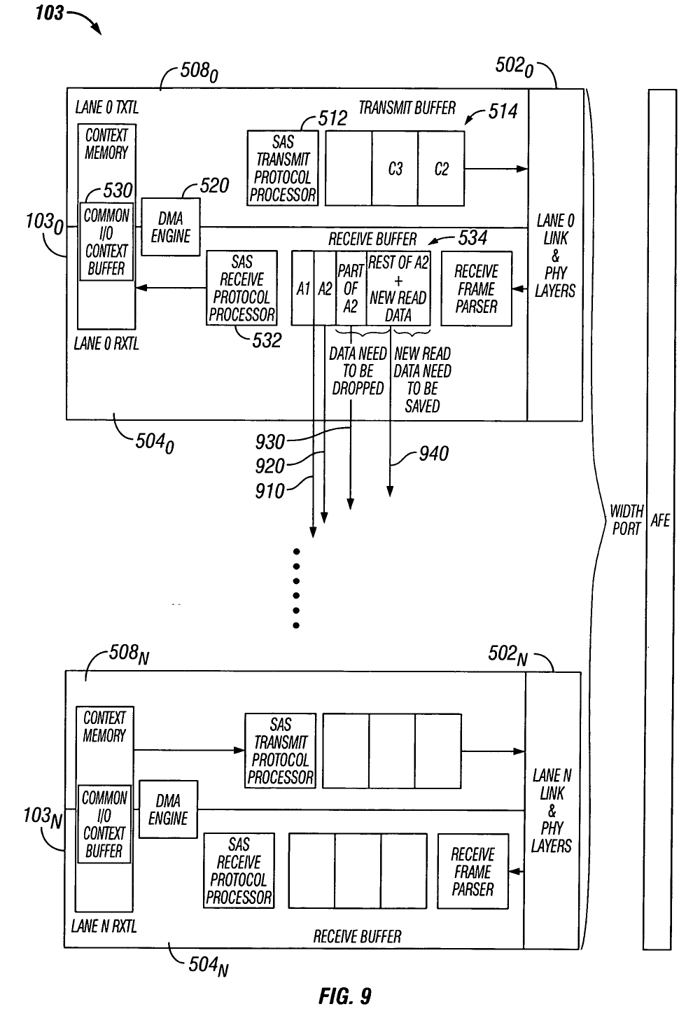

Lastly, with reference to FIG. 9, FIG. 9 is a block diagram illustrating how the SSP initiator port 103 handles read data frame retries as part of a transport layer retry (TLR) mechanism for I/O read commands.

When an SSP target port retransmits read data frames for an ITLQ nexus due to a ACK/NAK timeout or receives a NAK, it is required to retransmit all the read data frames from the last ACK/NAK balance point (e.g. as shown at point 910 in FIG. 9). The SSP initiator port 103 may have no information to figure out the last ACK/NAK balance point in the SSP target port. To solve this problem, the SSP initiator port 103 updates the dynamic fields in the common I/O context buffer 530 for all of the last good read data frames received for each of the outstanding initiator read commands.

As shown in FIG. 9, when any received transport layer (e.g. 504₀) of a wide port receives a read data frame with the CHANGING DATA POINTER bit set to one (e.g. the first retransmitted read data frame for an ITLQ nexus), the receive transport layer utilizing the SAS receive protocol processor 532 and the common I/O context buffer 530 verifies that the read data frame is a valid retransmitted data frame. This is done by checking the read data frames data offset field less than or equal to the I/O context dynamic's I/O read/write data relative offset field. If the read data frame is valid, the SSP TLR process can begin. It should be noted that each time the DMA processor 520 reads a data frame out of the received buffer, that the receive transport layer updates the dynamic fields according to the size of the read data frames. In this example, the last good received data frame is A2.

If the read data frames data offset field is less than the I/O context dynamic's I/O read/write data relative offset, the SSP initiator port 103 jumps to discard mode (for this particular ITLQ nexus) and discards all the read data bytes received for that ITLQ nexus until the saved dynamic's read/write data relative offset has been reached; then it switches back to the normal receive mode to save all future data bytes for this particular ITLQ nexus. On the other hand, if the read data frame's data offset field is equal to the I/O context dynamic's input/output read/write data offset field, it just enters the normal receive mode to save all data bytes for this particular ITLQ nexus.

Looking at the particular example shown in FIG. 9 at point 920 the SSP initiator port 103 receives A2 and a response with an ACK—but the ACK is lost in transport. Based on this, an ACK/NAK timeout occurs and the SSP target port reopens a new connection and retransmits all the read data frames from the last ACK/NAK balance point. At point 930, the read data frames CHANGING DATA POINTER bit is set to one and the read data frames offset field is less than the input/output context's input/output read/write offset. Thus, the receive transport layer 504₀ enters a discard mode and discards all the read data until the last good received read data frame's relative offset.

Then, at point 940 in FIG. 9, the receive transport layer 504 returns back to normal mode and saves all the new good read data bytes.

According to embodiments of the invention, a complete hardware automated mechanism to handle SSP initiator port transport layer retries, requiring virtually no assistance from firmware at all, is disclosed. In this way, firmware overheads are significantly reduced and there is a significant reduction in CPU compute cycle time and handshaking between firmware and hardware. This translates into improved overall system performance and improved SAS protocol control performance, especially, in multiple protocol applications. Moreover, the firmware design that is still required is substantially simplified, especially in large storage system environments and the real time handling requirements from the firmware is significantly reduced.

Further while the embodiments of the invention have been described with reference to illustrated embodiments, these descriptions are not intended to be construed in the limiting sense. Various modifications of the illustrative embodiments, as well as other embodiments of the invention, which are apparent to persons skilled in the art to which embodiments of the invention pertained, are deemed to lie within the spirit and scope of the invention.

What is claimed is:

1. An apparatus comprising:
a circuit including a transmit transport layer and a receive transport layer, the transmit and receive transport layers being coupled to a link;
a transmit protocol processor of the transmit transport layer to control a transport layer retry (TLR) mechanism in a serialized protocol; and
a receive protocol processor of the receive transport layer coupled to the transmit protocol layer to control the TLR mechanism in the serialized protocol.

2. The apparatus of claim 1, wherein, the serialized protocol is compatible with a Serial Attached (Small Computer System Interface (SCSI)) (SAS) protocol standard.

3. The apparatus of claim 1, further comprising a task nexus to identify an initiator port, a target port, a logical unit, and a task.

4. The apparatus of claim 3, further comprising an input/output (I/O) context buffer of the transmit transport layer to store an I/O context for the task nexus.

5. The apparatus of claim 4, wherein, the I/O context buffer stores dynamic and snapshot fields related to the task nexus.

6. The apparatus of claim 4, further comprising a transmit buffer located in the transmit transport layer coupled to the link, the transmit buffer to store retry write data under the control of the transmit control processor and based upon the I/O context for the task nexus for subsequent transmission onto the link.

7. The apparatus of claim 3, further comprising an input/output (I/O) context buffer of the receive transport layer to store an I/O context for the task nexus.

8. The apparatus of claim 6, wherein, the I/O context buffer stores dynamic and snapshot fields related to the task nexus.

9. The apparatus of claim 1, wherein, the circuit is an integrated circuit.

10. A method comprising:
controlling a transmit protocol processor coupled to a link to provide a transport layer retry (TLR) mechanism in a serialized protocol; and
controlling a receive protocol processor coupled to the link to provide a TLR mechanism in the serialized protocol; and
defining a task nexus to identify an initiator port, a target port, logical unit, and a task.

11. The method of claim 10, wherein, the serialized protocol is compatible with a Serial Attached (Small Computer System Interface (SCSI)) (SAS) protocol standard.

12. The method of claim 10, further comprising storing an (I/O) context for the task nexus.

13. The method of claim 12, wherein, the I/O context includes dynamic and snapshot data related to the task nexus.

14. The method of claim 13, further comprising storing retry write data under the control of the transmit control processor based upon the I/O context for the task nexus for transmission on the link.

15. A controller comprising:
an initiator port circuit including:
a transmit transport layer including a transmit protocol processor coupled to a link, the transmit protocol processor to control a transport layer retry (TLR) mechanism in a serialized protocol compatible with a Serial Attached (Small Computer System Interface (SCSI)) (SAS) protocol standard; and
a receive transport layer including a receive protocol processor coupled to the transmit protocol layer and the link, the receive protocol processor to control the TLR mechanism in the serialized protocol compatible with the SAS protocol standard;
wherein the initiator port circuit communicates with a target port of a second controller of a storage device compatible with the SAS protocol standard.

16. The controller of claim 15, further comprising a task nexus to identify an initiator port, a target port, a logical unit, and a task.

17. The controller of claim 16, further comprising an input/output (I/O) context buffer of the transmit transport layer to store an I/O context for the task nexus including dynamic and snapshot fields related to the task nexus.

18. The controller of claim 17, further comprising a transmit buffer located in the transmit transport layer coupled to the link, the transmit buffer to store retry write data under the control of the transmit control processor and based upon the I/O context for the task nexus for subsequent transmission onto the link.

19. The controller of claim 16, further comprising an input/output (I/O) context buffer of the receive transport layer to store an I/O context for the task nexus including dynamic and snapshot fields related to the task nexus.

20. The controller of claim 15, wherein the initiator port circuit is an integrated circuit.
